(19) United States
(12) Patent Application Publication
(10) Pub. No.: US 2008/0270559 A1
(43) Pub. Date: Oct. 30, 2008

(54) Mobile Device and Method for Sending a Message from a Mobile Device

(75) Inventor: Zoran Milosavljevic, Gratkorn (AT)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/158,828

(22) PCT Filed: Dec. 21, 2006
(86) PCT No.: PCT/IB06/55005

§ 371 Date: Jun. 23, 2008

(30) Foreign Application Priority Data
Dec. 21, 2005 (EP) 05112560.7

(51) Int. Cl. G06F 15/16; G06F 3/048

(52) U.S. Cl. 709/206; 709/204; 715/810

(57) ABSTRACT

To provide a mobile device which facilitates the sending of a message and decreases the time needed for sending a message, a mobile device is proposed comprising a message creating unit (MCU) which creates a message having one or more message attributes and/or a message content. A recipient database (RDB) stores at least one recipient identification representative of an addressee. An analyzing unit (AU) analyzes the message attributes and/or the message contents, and generates a recipient list of at least one recipient identification based on the analyzed message attributes and/or message contents.

The present invention relates to mobile devices, a method for sending a message from a mobile device, and to a computer program for implementing said data processing method.

The usage of mobile devices, like cell phones, PDA's, notebooks etc has become commonplace nowadays. A common application of such mobile devices is the creation and transmission of messages, like SMS, MMS, fax, and email. The user typically selects a kind of message, e.g., a MMS, creates a contents, e.g. a text and a picture, chooses the recipient of the message from the internal address book and sends the message to the recipient. In the past endeavors have been made to facilitate the sending of such messages and to overcome barriers and drawbacks.

US 2003/0233420 A1 discloses a method and a system for content based routing of incoming messages. Since messages contain a set of self-descriptive attributes that convey what the message's content means, a processing engine can use these attributes to manipulate and process the message in order to permit advanced functionality such as routing of messages to any electronic device or messaging account, automatic formatting for various communications devices, automatic self-organization of messages within inboxes, etc. This is helpful to reduce time for organizing incoming messages by integrating individual's existing email boxes, cell phones, pagers, fax machines, telephones, and other devices. However, this does not facilitate the sending of a message.

US 2005/0198351 A1 discloses implementations for content based routing of incoming messages in an overlay network, which includes overlay nodes, such as routing nodes. Therein, routing nodes receive messages and return routing policies to the sending node based at least in part on content of the message. According to instructions included in the routing policies the sending node may modify the address in the message, so that the message is sent, e.g., directly to the intended destination. Thus, one or more intermediary nodes may be bypassed, and the latency in the overlay network may be reduced. However, also does not facilitate the sending of a message.

It is thus an object of the present invention to provide a mobile device which facilitates the sending of a message from the mobile device and reduces the time needed for sending a message.

The object is achieved according to the present invention by a mobile device as defined in claim 1, a method for sending a message from a mobile device as defined in claim 8 and a computer program as defined in claim 9.

Therefore, a mobile device is provided. A message creating unit creates a message having one or more message attributes and a message content. A recipient database stores at least one recipient identification representative of an addressee. An analyzing unit analyzes the message attributes and/or the message contents, and generates a recipient list of at least one recipient identification based on the analyzed message attributes and/or message contents.

Accordingly, a mobile device, such as a cell phone, a PDA, a notebook, etc., is provided that generates a list of addressees to which most likely a created message will be sent on the basis of the content and/or attributes of the message. The user can select one addressee from the list. Thereby the message communication is improved and the time needed to send a message is be reduced.

According to an aspect of the invention the recipient database comprises an identification database for storing the at least one recipient identification and an addressee information database for storing addressee information related to the at least one recipient identification.

According to a further aspect of the invention the mobile device comprises a display unit for displaying the recipient list. Additionally, the analyzing unit may comprise an analyzing database, an extracting unit, a listing unit and a selecting unit. The analyzing database stores at least one analyzing parameter based on message attributes and/or message contents and at least one relation between the at least one analyzing parameter and the at least one recipient identification stored in the recipient identification database. The extracting unit extracts analyzing parameters from the message. The listing unit generates the recipient list of at least one recipient identification to be displayed by the display unit. The selecting unit enables a selection of at least one recipient identification from the recipient list. Therefore, the mobile device supports the user the selection of a recipient of the message.

According to still a further aspect of the invention the mobile device comprises a message sending unit for sending the message to the selected recipient identification. It is further preferred, that the extracting unit extracts analyzing parameters from at least one sent message, and the analyzing database stores analyzing parameters and relations between analyzing parameters and the recipient identification of the at least one sent message.

According to an aspect of the invention the message is of the type SMS, MMS, email or fax, the recipient identification is at least one of an email address, a telephone number, a cell phone number, a fax number and a postal address, and the addressee information comprises at least one of name, birthday, religion, keyword, shortcut and residence. This keyword or shortcut name, birthday, religion, keyword, shortcut and residence may then be used to detect recipient.

The invention also relates to a method for sending a message from a mobile device. A message having one or more message attributes and/or a message content is created. The message attributes and/or the message contents are analyzed. A recipient list of at least one recipient identification representative of an addressee from recipient database is generated based on the analyzed message attributes and/or message contents.

The message text may be analyzed and the receiver or addressee of the message is guessed by the mobile device, i.e. the most probable addressee is determined based on the actual text and/or attributes of the message. When the user types a message, e.g. a SMS (Short Message Service), on his mobile terminal, e.g. a cell phone, the mobile device analyzes the message and guesses the receiver (during writing or afterwards). The mobile device may, for example, detect names, analyze words (tokens) starting with capital letters, words after “Dear” or “Hello”, first letters, etc. It can create a list of two to three (or more) possible receivers and compare them with the phone book list of the phone. If one of them matches, the number should be displayed. If several match, a scrollable list is displayed. If there is no match the recipient to which the last message was sent is listed or the one to which most frequently messages were sent. Anyway, if the user types a number, all suggestions disappear. The whole function should be selectable to be switched on or off.

Further aspects of the invention are defined in the dependent claims.

The embodiments and advantages of the invention will now be described in more detail with reference to the drawings.

FIG. 1 shows a block diagram of a mobile device according to a first and second embodiment of the invention,

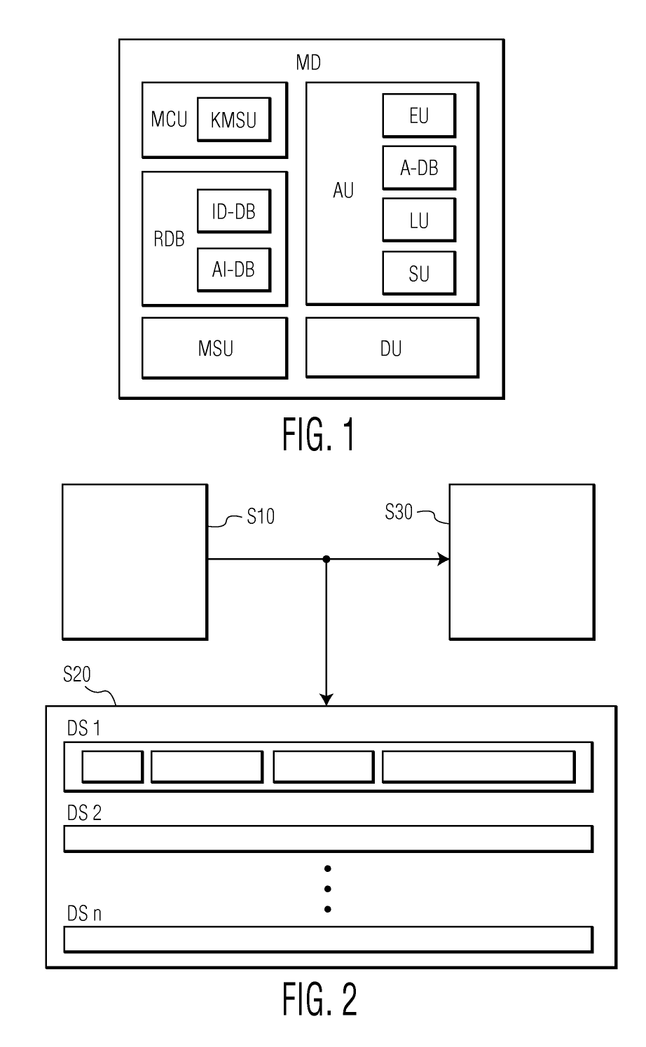

FIG. 2 shows an illustration of the operation of the mobile device according to FIG. 1,

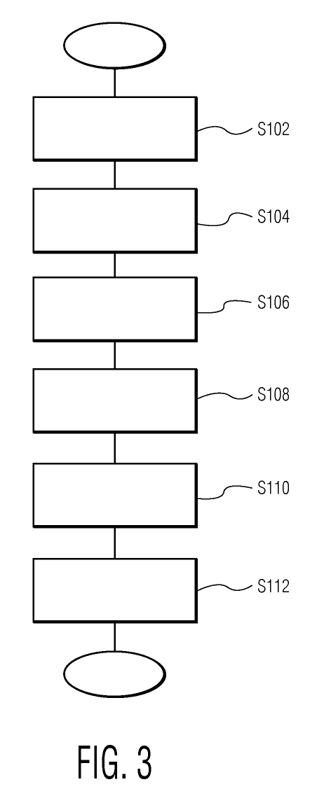

FIG. 3 shows a flowchart of the operation of the mobile device according to a first embodiment of the invention,

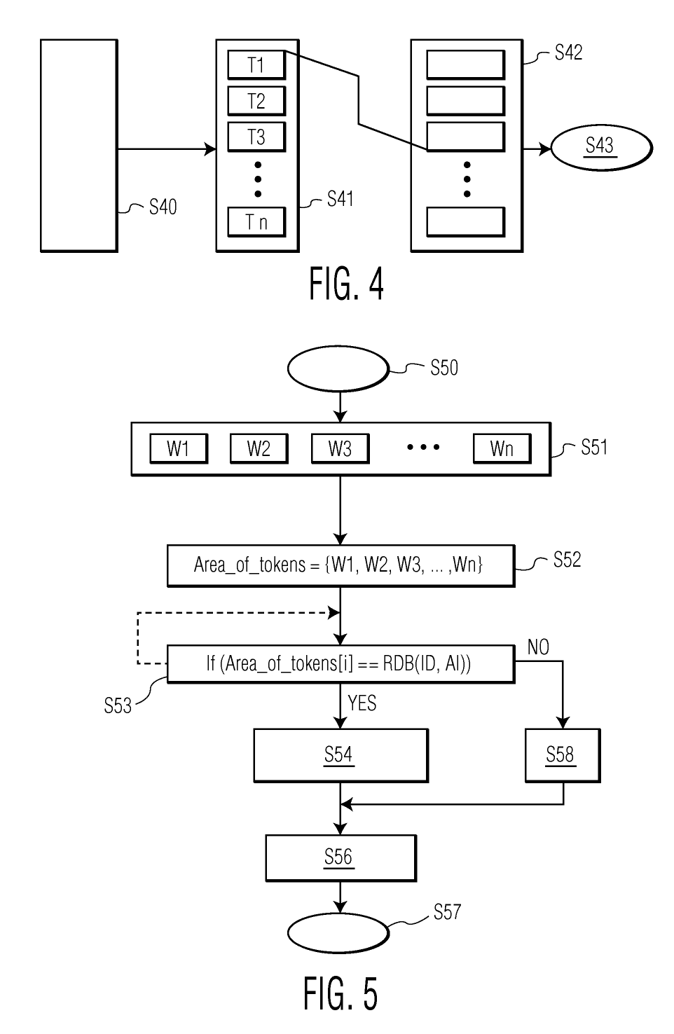

FIG. 4 shows a further illustration of the operation of the mobile device according to FIG. 1,

FIG. 5 shows flowchart of the operation of the mobile device according the invention,

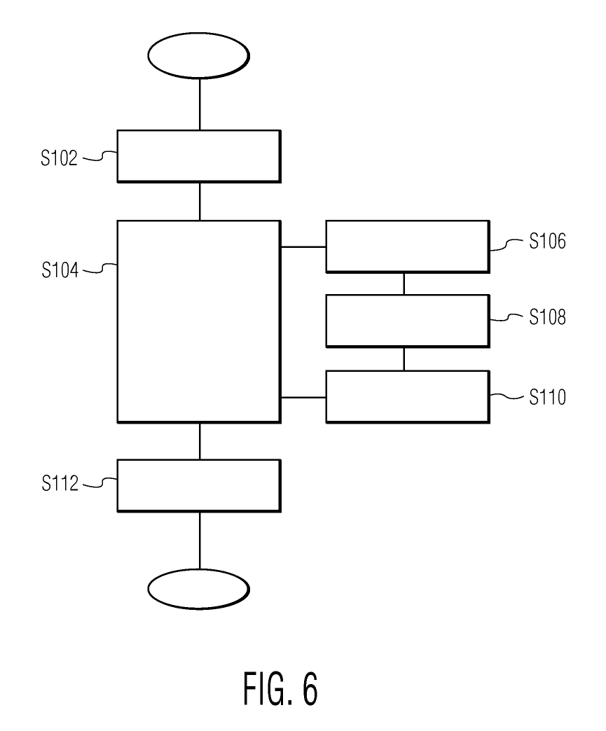

FIG. 6 shows a flowchart of the operation of the mobile device according to a second embodiment of the invention, and

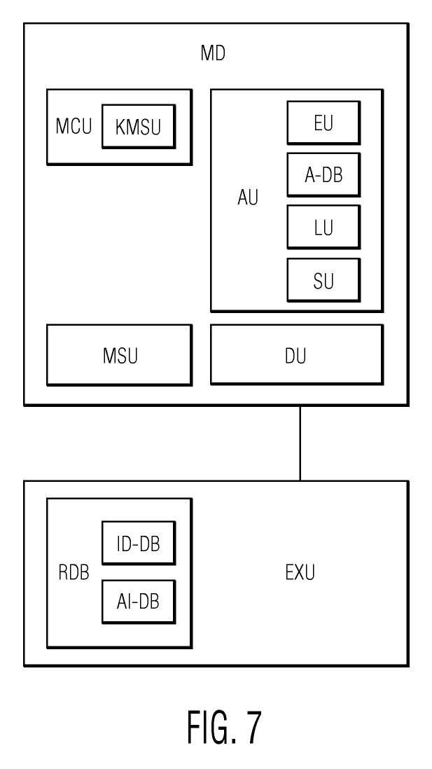

FIG. 7 shows a block diagram of a mobile device according to a third embodiment of the invention.

FIG. 1 shows a mobile device MD according to a first embodiment of the invention. The mobile device MD comprises at least a message creating unit MCU, a recipient database RDB, a message sending unit MSU, an analyzing unit AU and a display unit DU.

The message creating unit MCU serves to create a message. The message creating unit MCU further comprises a kind of message selecting unit KMSU for selecting a kind of message first. A message may include all kinds of data, which can be sent from mobile devices, for example, the formats SMS (Short Message Service), MMS (Multimedia Messaging Service), email, fax, etc. A message has message attributes and message contents. Message attributes include, for example, the kind of message (SMS, MMS, email, fax, etc.), the time, when the message is created or when it shall be sent (for example in the early morning, in the evening, during lunch break), the day of the week (e.g., Monday, workday or weekend), the date (e.g., a birthday, a holiday), the length and size of the message (number of signs or the size below a threshold, single message, concatenated message), the character set (Latin, Cyrillic, Greek, etc.), the font (color, size, type, etc.), the validity (an hour, a day, etc.), and the frequentness etc.

The message contents may include, for example, self descriptive key words (e.g. names, synonyms, nick names, abbreviations, e.g. hdl, vlg, :-), and shortcuts, e.g. T for Thomas), prefixed or suffixed key words (e.g. salutation, complementary closes, title, address), attachments (e.g. pictures) and other indications (e.g., small and capital letters, first letters).

In the recipient database RDB at least one recipient identification (recipient ID) of an addressee, for example, in form of a telephone number, is stored as obligatory information. The recipient database RDB may comprise an ID database ID-DB and an addressee information database AI-DB. On the one hand an addressee may have one or more recipient IDs, e.g. one or more private and business email addresses, telephone numbers, cell phone numbers, fax numbers, postal addresses, etc. The recipient IDs may be stored in the ID database ID-DB. On the other hand an addressee has addressee information, like a name, a birthday, a religion, a home country/residence etc., whereof the latter can be used, for example, to identify national or religious holidays. The addressee information as facultative information may be stored in the addressee information database AI-DB. The ID database ID-DB and the addressee information database AI-DB are coupled in that way that the addressee information and the one or more recipient IDs of an addressee are linked, respectively.

The message sending unit MSU allows the sending of messages to the recipient ID representative of an addressee provided by the recipient database RDB.

The analyzing unit AU analyzes the message, especially message attributes and message contents. The analyzing unit AU may comprise an analyzing database A-DB, an extracting unit EU, a listing unit LU and a selecting unit SU. The analyzing database A-DB provides one or more analyzing parameters in the form of message attributes and message contents, and one or more relations between analyzing parameters and addressees, respectively. Furthermore the analyzing database A-DB stores analyzing parameters and relations of sent messages. Thereby a kind of history is obtained and can be used for later analyses, i.e. the analyzing unit learns.

The extracting unit EU extracts analyzing parameters from the message provided in the message creating unit MCU. The listing unit LU generates a list of one or more addressees, e.g. in the form of a recipient ID, based on the analyzing parameters extracted by the extracting unit EU in combination with the relations stored in the analyzing database A-DB. The selecting unit SU allows a selection of one or more addressees, e.g. in the form of a recipient ID, from among the list provided by the listing unit LU, and forwards this to the message sending unit MSU. The display unit DU allows to display at least the generated recipient list.

Alternatively, the recipient database and the analyzing database may be stored in a common memory, for example, a memory card, and may be exchangeable.

FIG. 2 shows an illustration of the operation of the mobile device according to FIG. 1. In step S10 a SMS message SMS msg is selected and the text thereof starts with “Hello Tom”. Accordingly, in step S20 a first dataset DS1 of the addressee information database AI-DB may contain the message attributes “SMS”, the message content “Hello Tom”, and the relation to “Thomas” in the addressee information database AI-DB connected with the recipient ID “cell phone number”. In step S30, based on the first dataset DS1 the message is sent to the cell phone number of Thomas as the relation to “Thomas” is stored in the dataset DS1. The other dataset DS2-DSn do not contain an appropriate relation to the text such that they are not considered.

FIG. 3 shows a flowchart of a data processing method according to the first embodiment of the invention. In a first step (S102) the user chooses a kind of message, for example, a MMS, by means of the kind of message selecting unit KMSU of the message creating unit MCU. In a next step (S104) the user creates a message, for example, the user chooses a picture to be sent as MMS and/or writes a text. In a further step (S106) the message is analyzed by the analyzing unit AU, which will include the extraction of analyzing parameters from the message by the extraction unit EU, i.e. the extraction unit EU determines if there are message attributes and message contents which match one or more analyzing parameters stored in the analyzing database A-DB. For example, if an MMS is created comprising a picture and a corresponding text, the extraction unit EU determines, for example, the name of the picture, and words in the text. In the next step (S108) the listing unit LU provides a recipient list. If there are matches the listing unit LU provides a recipient list of one or more addressees based on the relations between analyzing parameters and addressees stored in the analyzing database A-DB. If there is no match, the listing unit LU provides a recipient list of one or more addressees with, the most frequently addressed one and/or the last addressed one. The recipient list is displayed on the display unit DU.

In a next step (S110) in the selecting unit SU the user may select one or more addressees from the recipient list. If an addressee has more than one recipient ID the user also selects a recipient ID. If the addressee to which the message has to be sent is not listed, the user may either type a number or access the recipient database, for example, a phone book, in order to choose an addressee and a recipient ID, and the recipient list disappears. In a last step (S12) the message is sent by the message sending unit MSU to the selected recipient ID.

Alternatively, the recipient list may comprise at least one of the options to type the recipient ID, e.g. a phone number, or to consult the recipient database RDB, e.g. a phone book. Additionally, when the user types a recipient ID, e.g. a phone number, the listing unit LU could suggest all recipient IDs, e.g. phone numbers, stored in the recipient database RDB which include the already written part of the recipient ID. Alternatively, the analyzing step (S106) could be performed simultaneously with the creating step (S104).

FIG. 4 shows a flowchart of the operation of the mobile device according to a first embodiment of the invention. In step S40 a message MSG is created. The message can be a SMS, a MMS or the like. The attributes of the message is extracted and the message is divided or extracted into tokens T1-Tn (step S41). The tokens T1-Tn are matched with addresses Addr1-Addrn stored in the recipient database RDB (step S42). Here, the token T1 matches with the address Addr3. Therefore, the message MSG is sent to the address Addr3 (step S43).

FIG. 5 shows flowchart of the operation of the mobile device according the invention. The flow starts in step S50. In step S51 a message MSG is created with words W1-Wn. The message MSG is tokenized and an extraction is preformed (Step S52). In step S53 it is determined whether the tokens from step S52 correspond to any information, entry or dataset in the recipient database RDB (like the identification ID or the address information). If one of the tokens match with a dataset in the recipient database RDB, then the message MSG is sent to a recipient according to the dataset (step S54). Thereafter, the analyzing unit AU is updated, i.e. the analyzing unit AU stores the information that this message is sent to the recipient because of a match of a token with one of the datasets in the recipient database RDB. The flow ends in step S57.

If in step S53 none of the tokens match a dataset in the recipient database RDB then the message MSG can be sent to the last recipient or the most frequently used recipient. Thereafter, the flow continues to step S56 and the analyzing unit AU is updated.

FIG. 6 shows a flowchart of a data processing method according to a second embodiment of the invention. According to the second embodiment the analyzing database A-DB additionally stores relations between contents, for example, between “Dear Mrs.” and “Yours faithfully”, or between “Thomas” and the attachment “tom.jpg”. Here, both the analyzing step (S106), the listing step (S108) and the selecting step (S110) may be performed simultaneously with the creating step (S104). In the listing step (S108) the listing unit LU then provides a list comprising one or more addressees as well as one or more text modules or enclosures, for example, by names or suffixes, based on the relations between analyzing parameters and addressees and based on the relations between contents; the relations stored in the analyzing database A-DB. For example, the extracting unit EU identifies “Dear Thomas”. Based on the relation stored in the analyzing database A-DB the listing unit LU proposes “Insert tom.jpg” and “Send to Thomas”. Then, in the selecting step (S110) the user either chooses a content to be inserted or an addressee, or continues typing the message, so that the list disappears.

FIG. 7 shows a block diagram of a mobile device according to a third embodiment of the invention. According to the third embodiment, the recipient database RDB is embodied as an external unit and is connected with the mobile device MD by means of an interface. The message creating unit MCU, the analyzing unit AU, the message sending unit MSU and the display unit DU of mobile device MD according to the third embodiment correspond to the message creating unit MCU, the analyzing unit AU, the message sending unit MSU and the display unit DU of mobile device MD according to the first embodiment.

The provision of an external recipient database allows to use several mobile devices with the same recipient database. In this embodiment the result of the extracting unit EU is transmitted to the listing unit LU which connects the recipient database RDB via the interface and provides a list of the most likely addressees based on the relations between analyzing parameters and addressees stored in the analyzing database A-DB. The list is displayed by the display unit DU of the mobile device MD.

Additionally, the listing unit may operate as an external unit. Further, the interface may be a wireless interface.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Mobile device, comprising:
a message creating unit for creating a message having one or more message attributes and a message content,
a recipient database for storing at least one recipient identification representative of an addressee, and
an analyzing unit for analyzing the message attributes and/or the message contents, and for generating a recipient list of at least one recipient identification based on the analyzed message attributes and/or message contents.

2. Mobile device according to claim 1, wherein the recipient database comprises an identification database for storing the at least one recipient identification and an addressee information database for storing addressee information related to the at least one recipient identification.

3. Mobile device according to claim 1, further comprising:
a display unit for displaying the recipient list,
wherein the analyzing unit further comprises:
an analyzing database for storing at least one analyzing parameter based on message attributes and/or message contents and at least one relation between the at least one analyzing parameter and the at least one recipient identification stored in the recipient identification database,
an extracting unit for extracting analyzing parameters from the message,
a listing unit for generating the recipient list of at least one recipient identification to be displayed on the display unit, and/or
a selecting unit for enabling a selection of at least one recipient identification from the recipient list.

4. Mobile device according to claim 3, further comprising:
a message sending unit for sending the message to the selected recipient identification,
wherein the extracting unit extracts analyzing parameters from at least one sent message and the analyzing database (A DB) stores analyzing parameters and relations between analyzing parameters and the recipient identification of the at least one sent message.

5. Mobile device according to claim 1, wherein the message is of the type SMS, MMS, email and/or fax.

6. Mobile device according to claim 2, wherein the recipient identification is an email address, a telephone-number, a cell phone number, a fax number and/or a postal address.

7. Mobile device according to claim 1, wherein the addressee information comprises at least one of name, birthday, religion, keyword, shortcut and residence.

8. Method for sending a message from a mobile device, comprising the steps of:
creating a message having a message content and/or one or more message attributes,
analyzing the message attributes and/or the message contents, and
generating a recipient list of at least one recipient identification representative of an addressee from recipient database based on the analyzed message attributes and/or message contents.

9. Computer program comprising computer program code means for causing a mobile device to perform the steps of the method as claimed in claim 8 when said computer program is run on a mobile device.
